(19) United States
(12) Patent Application Publication
(10) Pub. No.: US 2010/0191560 A1
(43) Pub. Date: Jul. 29, 2010

(54) Pharmaceutical Sample Management for a Sales Call

(75) Inventors: Darshan Kumar, San Ramon, CA (US); Ambili Sudhi, Bangalore (IN); Govindraja Achar, Bangalore (IN); Pankesh Jhaveri, North Brunswick, NJ (US); Harish Kumar, Bangalore (IN); Walter Back, San Jose, CA (US)

Correspondence Address: Squire, Sanders & Dempsey L.L.P.;Oracle International Corporation, 8000 Towers Crescent Drive, 14th Floor, Vienna, VA, 22182, US

(73) Assignee: Oracle International Corporation, Redwood Shores, CA (US)

(21) Appl. No.: 12/362,409

(22) Filed: Jan. 29, 2009

(51) Int. Cl. G06Q 10/00; G06Q 50/00

(52) U.S. Cl. 705/7

(57) ABSTRACT

Systems and methods are provided record details about sample products left with a customer/physician during a sales call presentation. A Pharmaceutical Sample Management (“PSM”) system performs a validation process on call detail data entered by a sales representative. The PSM system performs validation for all applicable rules in one iteration and presents any errors to the user in a unified view. Furthermore, rules may be applied “out-of-the-box,” customized, or created by users themselves. Accordingly, the sales representative may quickly create an accurate record, and the physician can sign off on it in order to comply with government regulations.

### FIELD OF THE INVENTION

One embodiment is directed to customer relationship management, and more particularly directed to sample management during a sales call.

### BACKGROUND INFORMATION

In recent years, the annual rate of increase among physicians has remained relatively flat while the number of pharmaceutical sales representatives has grown considerably overall, even accounting for recent reductions in field force sizes. As a result, sales call effectiveness has waned in the face of a changing market and physicians' increasingly busy schedules, forcing life sciences organizations to transform their sales and marketing capabilities. Pharmaceutical companies face stiff challenges in terms of completion, cost escalation and reduction in margins, while promoting their products by sending out sales representatives to doctors, hospitals and other medical organizations. Typically the sales representatives, in the few minutes that they get with the audience/doctors, orally explain the complicated details of the medical product and then give handouts, such as presentation material on the product in paper form. A very likely result of such an approach is that after the session the audience would have already forgotten much, depending on the oral presentation skills of the representative, and the handouts most likely be thrown away. Furthermore, the sales representative may not come away with a written or other record of the presentation such as how much time was spent addressing the various details of the product, or what samples were left with the physician.

Government bodies such as the Food and Drug Administration (“FDA”) regulate the dispensing of pharmaceutical samples to physicians by sales representatives. For example, there is a rule that a physician must have a valid license to accept samples from a sales representative. Pharmaceutical companies are required to follow these rules, and often imposes their own rules on sales representatives. For example, a pharmaceutical company might require a sales representative to set an objective for a sales call.

During the call, the sales representative records details about the call, such as the physician's name and license number, products discussed, samples dropped, etc. The sales representative then acquires the signature of the physician acknowledging samples dropped, and submits the call details to a home office. Before acquiring the signature of the physician, or before submitting call details to the home office, the call details must be evaluated and it must be determined whether all sample compliance rules are met and correct. If there is noncompliance, the sales representative needs to correct or complete that issue before continuing with signing or submitting.

Typically, there may be twenty conditions to be met before signing and/or submitting. In prior customer relationship management (“CRM”) software such as Oracle® Life Sciences Version 7.0, a data validation process starts when the signing or submitting is commenced. If a particular validation rule fails, for example, if the physician license number is invalid, the validation process aborts and the sales representative is informed of the error. This cycle repeats until all rules and conditions are satisfied, which can be a time-consuming and aggravating process. Furthermore, the sales representative sometimes needs to navigate to different views to correct the error. For example, for modifying physician license details the sales representative needs to navigate to a contact information screen, or for correcting sample details the sales representative needs to navigate to a sample product screen. After navigating to that screen, the sales representative may forget the error message and then must navigate back to Call Details Screen and initiate a Validation process to see the error message.

### SUMMARY OF THE INVENTION

One embodiment is a system for validating sales call data. The system receives a request to validate the sales call data and retrieves a rules list including a plurality of rules for validating the sales call data. The system then selects a subset of rules to apply to the sales call data from the plurality of rules based on rule criteria in the rules list and validates the sales call data in accordance with the subset of rules. The rules are all applied in one iteration before presenting a user with a list of rules that failed.

### BRIEF DESCRIPTION OF THE DRAWINGS

FIG. 1 is a block diagram of a system that can implement a Pharmaceutical Sample Management (“PSM”) system in accordance with an embodiment;

FIG. 2 illustrates a method of providing Pharmaceutical Sample Management and analytics in accordance with an embodiment;

FIG. 3 illustrates example call details user interface (“UI”) of the PSM system in accordance with an embodiment;

FIG. 4A illustrates a screenshot of an example UI with an inefficient validation process;

FIG. 4B illustrates another screenshot of an example UI with an inefficient validation process;

FIG. 5 illustrates an example rules list accordance with an embodiment;

FIG. 6 illustrates an example rules result list in accordance with an embodiment;

FIG. 7 illustrates a method of validating sample data for a sales call in accordance with an embodiment;

FIG. 8A illustrates a screenshot of an example UI for validating sample data in accordance with an embodiment; and

FIG. 8B illustrates a screenshot of another example UI for validating sample data in accordance with an embodiment.

### DETAILED DESCRIPTION

Embodiments are directed to systems and methods for recording details about sample products left with a customer/physician during a sales call presentation. A Pharmaceutical Sample Management (“PSM”) system performs a validation process on call detail data entered by a sales representative. The PSM system performs validation for all applicable rules in one iteration and presents any errors to the user in a unified view. Furthermore, rules may be applied “out-of-the-box,” customized, or created by users themselves. Accordingly, the sales representative may quickly create an accurate record, and the physician can sign off on it in order to comply with government regulations.

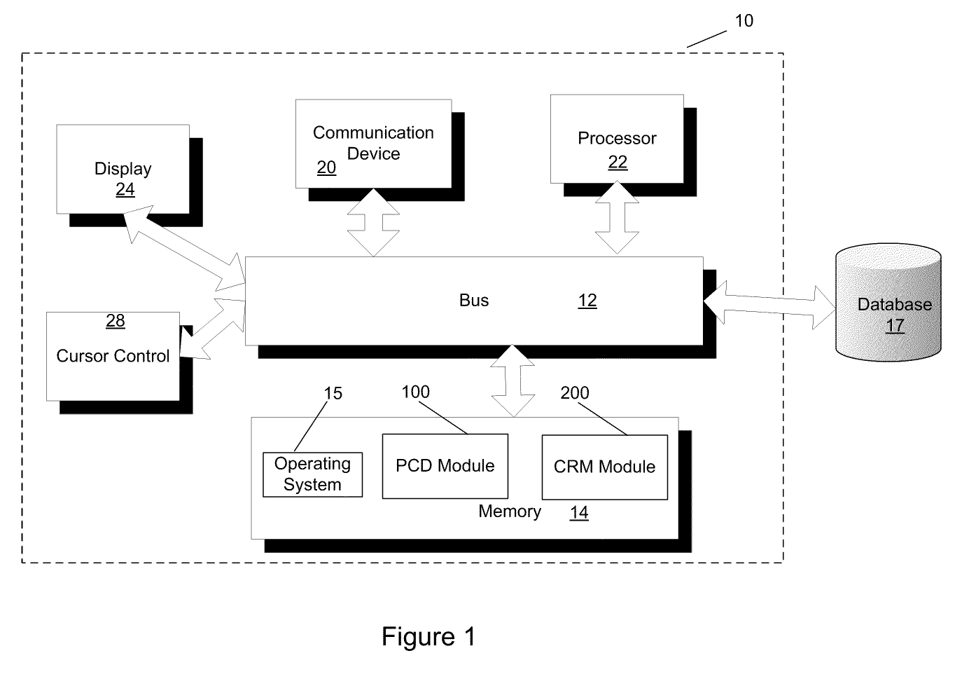

FIG. 1 is a block diagram of a system 10 that can implement an embodiment of a PSM system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A cursor control device 28, such as a touch screen, is further coupled to bus 12 to enable a user to interface with system 10. In one embodiment, system 10 is a tablet PC.

In one embodiment, memory 14 stores software modules that provide functionality when executed by processor 22. The modules include an operating system 15 that provides operating system functionality for system 10, and a customer relationship management (“CRM”) module 200 that provides enterprise-level applications for customer relationship management. The modules further include a PSM module 100, which is described in greater detail below. System 10 may be coupled to a database 17 for storing additional data.

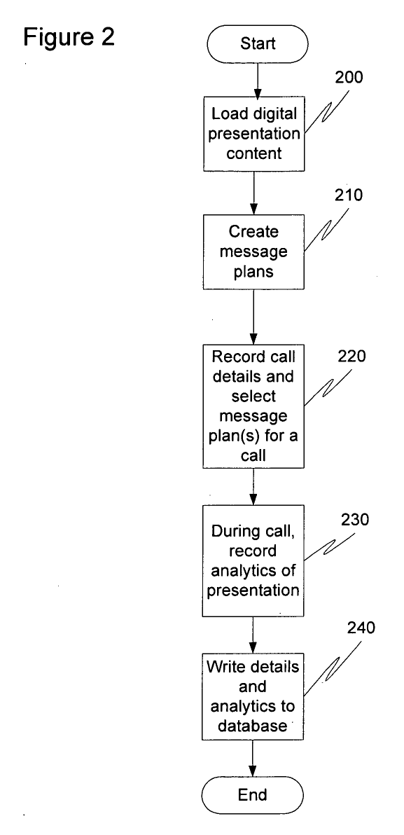

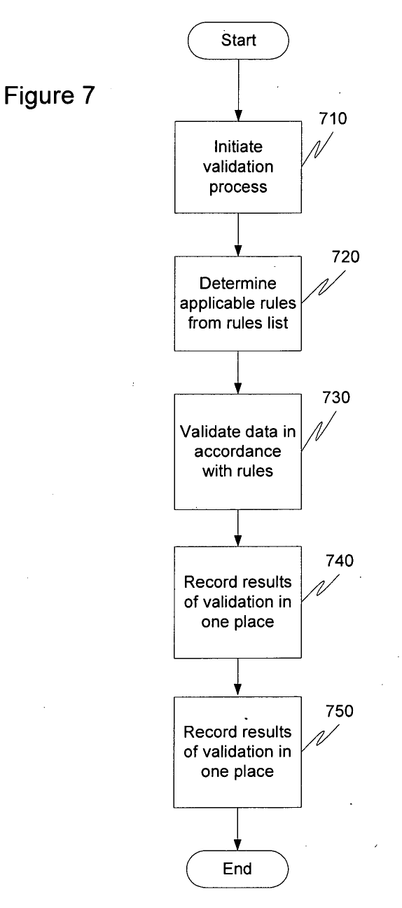

FIG. 2 illustrates a flow diagram of the functionality of PSM module 100 in accordance with an embodiment. In one embodiment, the functionality of the flow diagram of FIG. 2, and FIG. 7 below, is implemented by software stored in memory and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software. Initially, digital presentation content is loaded on the PSM system 10 (200). Digital presentation content may be used by brand managers, marketing managers and sales operation managers as a sales communication tool for more effective communication in order to acquire, retain and develop profitable customer relationships and improve marketing and sales effectiveness. Examples of digital presentation content includes presentations in the form of Flash files, PowerPoint files, word documents, movie files, Portable Document files, etc. A “message” refers to a slide, page or segment of a presentation conveying a specific message that managers wish to track.

After loading the digital presentation content on PSM system 10, an administrator or manager may then create a “messaging plan” for the sales representative to use (210). The messaging plan is a sequence of digital presentation content used to deliver the tracked message regarding the product. When a sales representative makes a sales call, a messaging plan is selected on the PSM system 10 and details about the call are entered into the system (220). During the sales call, the PSM system 10 dynamically and automatically collects analytical data such as time spent by the sales representative on each presentation slide and the sequence of slide presentation (230). For example, PSM system may include a timer (not shown) for recording the time spent on each slide or segment of the presentation.

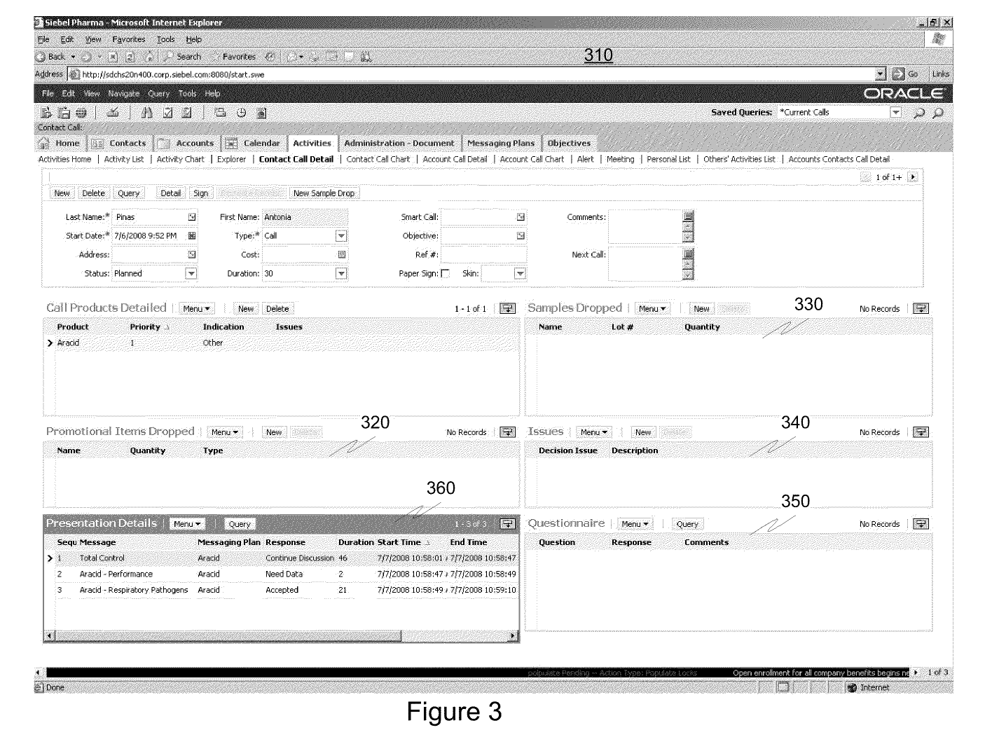

Once the sales presentation is over, the analytical data collected during the session is written back to database 17 (240). At the end of the sales call, the sales representative may also enter additional details about the sales call such a samples and promotional items left with the doctor or audience, issues about the call, or questionnaires dropped during the call. FIG. 3 illustrates an example screenshot of a UI 310 for PSM system 10 where the sales representative can enter call details in promotional items section 320, samples dropped section 330, issues section 340, and questionnaires section 350. The screenshot UI 310 displays in presentation details section 360 the messages that were presented to the contact in the detailing session, the sequence of presented messages and their parent messaging plans (i.e., the messaging plan to which the messages belong), and duration of presentation of each message. Ultimately, information about the sales call and other sales calls regarding the same product may be used to develop marketing strategies for that product based on the success of the sales calls.

Samples dropped section 330 allows the sales representative to record details about sample and promotional pharmaceutical products (hereinafter “samples”) that are left with a physician during a sales call. Government regulations often require that the sales representative keep accurate records of what samples are left with the physician, and the physician must “sign off” on the veracity of these records. However, during a sales call a sales representative often has very little time with the physician, and thus it is difficult to keep these records without wasting the physician's time. In a typical CRM application for the pharmaceutical industry, such as Oracle® Life Sciences, data entry for the sample details requires too much time because of the numerous iterations of data validation when recording data about the sales call. As previously noted, the validation step typically cannot be postponed.

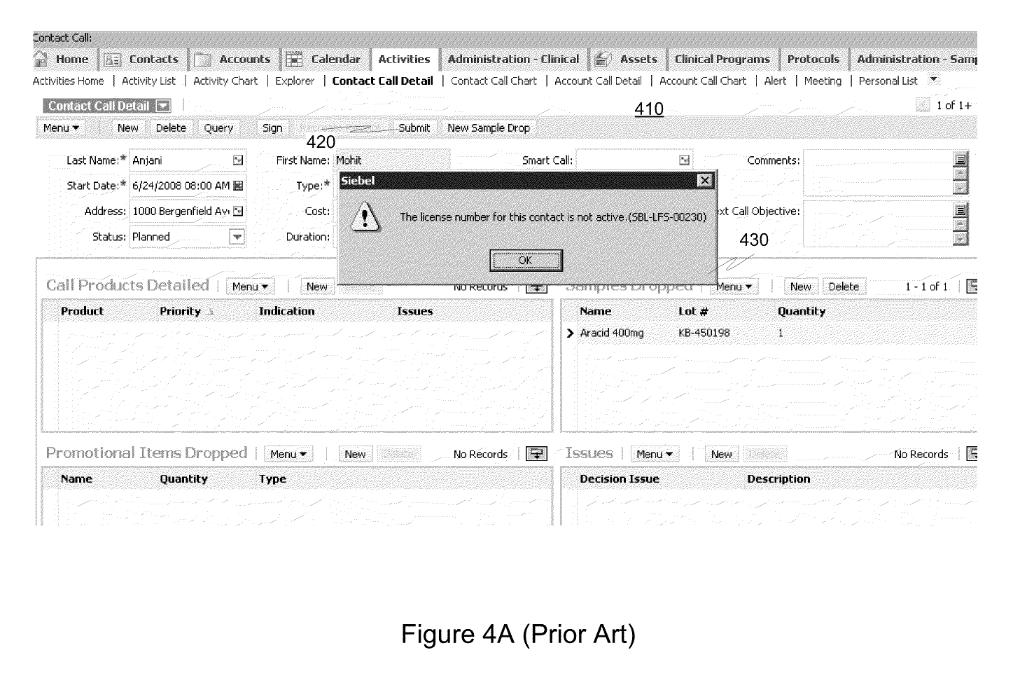

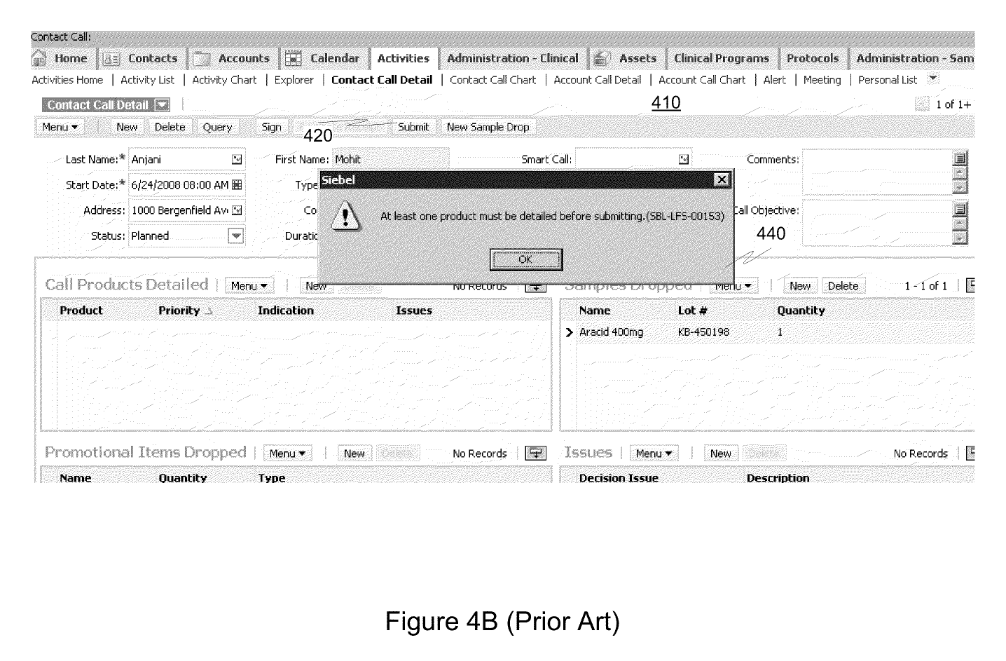

For example, FIGS. 4A-B illustrate an example screenshot of a UI 410 of a CRM application in the prior art where a sales representative enter details about the sales call. After the sales representative enters in data about the sales call, they click the submit button 420 and may receive error screen 430 shown in FIG. 4A. For example, error screen 430 may indicate that the physician data does not include a valid physician license number. After fixing the physician license number, the sales representative clicks the submit button 420 and may receive a different error screen 440 shown in FIG. 4B. For example, error screen 440 may indicate that the sales representative has failed to indicate a product for which a detailed presentation was given. Often, the user will have to navigate to different pages to correct errors and thus may forget what the error message said. Error messages may occur at any stage of the data entry process, thus interrupting the user and distracting them thus causing further error. This iterative validation process could go on and on, wasting the time of both the sales representative and the physician.

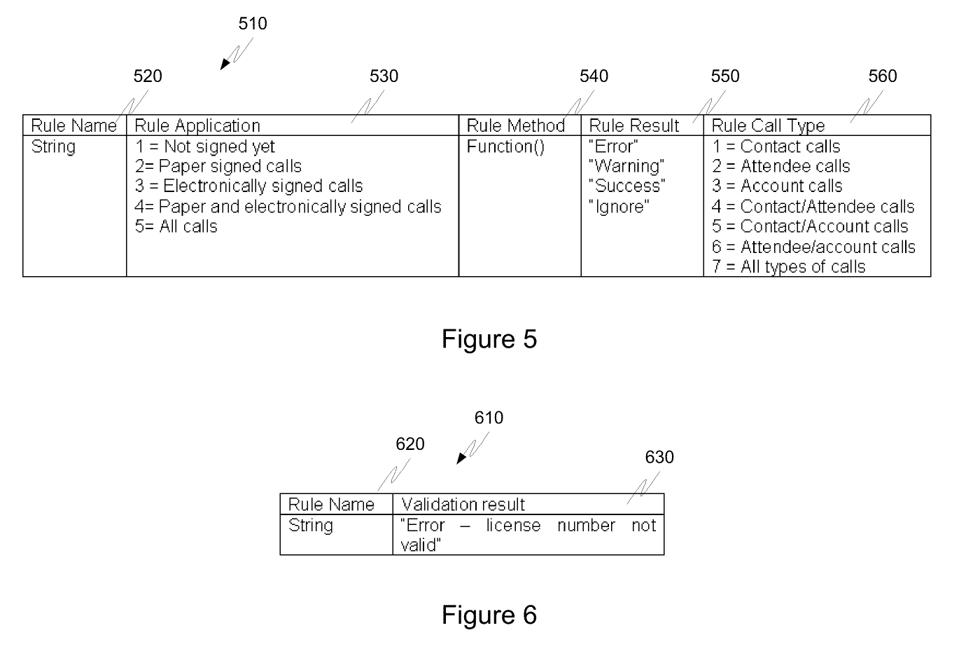

An embodiment of PSM system 10 includes a validation component that loads all rules for a sales call and validates the current sales call details against these conditions in one iteration. The results of the validation are stored in one location, and an overall validation status message is presented to the user with the opportunity to view details of any errors. FIG. 5 illustrates a example rules list 510 against which call data is validated in accordance with an embodiment. Rules list 510 includes a rule name property 520 which has a string indicating a name for the rule as its value. Rules list 510 further includes a rule application property 530 indicating when the rule should be processed depending on the call status. In this example, the term “call status” applies to whether and how the physician is to sign off on the sales call. Typically, the physician provides his signature either on a signed document, or as an electronic signature in PSM system 10. For example, a value of ‘1’ indicates that the rule should be applied if an electronic signature is expected but has not yet been entered. A value of ‘2’ indicates that the rule should be applied where a paper signature is submitted. A value of ‘3’ indicates that the rule should be applied where an electronic signature is submitted. A value of ‘4’ indicates that the rule should be applied where either a paper or electronic signature is submitted. A value of ‘5’ indicates the rule should be applied in all cases.

Rules list 510 further includes rule method property 540 indicating the method name of the function that applies the rule when the rule should be applied. Rules list 510 still further includes a rule result property 550 indicating a status message for the result of the rule. For example, if the validation of the rule fails, the result may be “Error” or “Warning” for that rule. If the validation succeeds, the result may be “Success.” If the rule is not applicable for this particular call, the result of validation may simply be “Ignored.”

Rules list 510 still further includes rule call type property 560 indicating the type of call for which the rule is applicable. For example, a value of ‘1’ may indicates the rule applies only to physician sales calls. A value of ‘2’ may indicate the rule applies only to conference attendees. A value of ‘3’ may indicate the rule applies to account clients such as organizations including hospitals and pharmacies. A value of ‘4’ may indicate the rule applies to both physician and attendee calls. A values of ‘5’ may indicate the rule applies to both physician and account calls. A value of ‘6’ may indicate the rule applies to both attendee and account calls. A value of ‘7’ may indicate the rule applies to all types of sales calls.

FIG. 6 illustrates a exemplary rules result list 610 for indicating the results of data that has been validated. Rules result list 610 includes a rule name property 620 which has a string indicating a name for the rule as its value. Rule name property 620 maps to rule name property 520. Rules results list 610 further includes validation result property 630 indicating the result of the rule validation. One of ordinary skill in the art will recognize that rules list 510 and rules results list 610 may be implemented as various kinds of data structures, including eXtensible Markup Language (“XML”) files, spreadsheet files, arrays, database tables, etc.

Rules list 510 can be customized by users by changing values in Properties 530, 540, 550 and 560. For example, a certain rule may have a value of ‘Error’ in Property 550, which can be changed to ‘Warning’ or ‘Ignore.’ The value in property 560 may be changed from ‘1’ (meant for ‘Contact call’) to any value between ‘2’ and ‘7’. The method name in property 540 can also be changed to any other method name, including a method name of a new validation function written by a user. For example, if users want to change the way physician's license number is validated, they will write a new script and refer to that script's name in property 540.

FIG. 7 illustrates a method for validating sales call data in accordance with an embodiment. After a sales representative has finished detailing the sales call and entering the required data, the sale representative initiates validation (710). PSM system 10 loads validation rules (e.g., rules list 510) and determines which rules are applicable based on the criteria of the validation rules (720). PSM system 10 then validates the entered data in accordance with the applicable validation rules (730). Then, PSM system 10 records the results of the data validation, e.g., in database 17 (740). Finally, PSM system 10 alerts the user of the validation results, and provides a link to view details of validation successes, errors, and warnings (750).

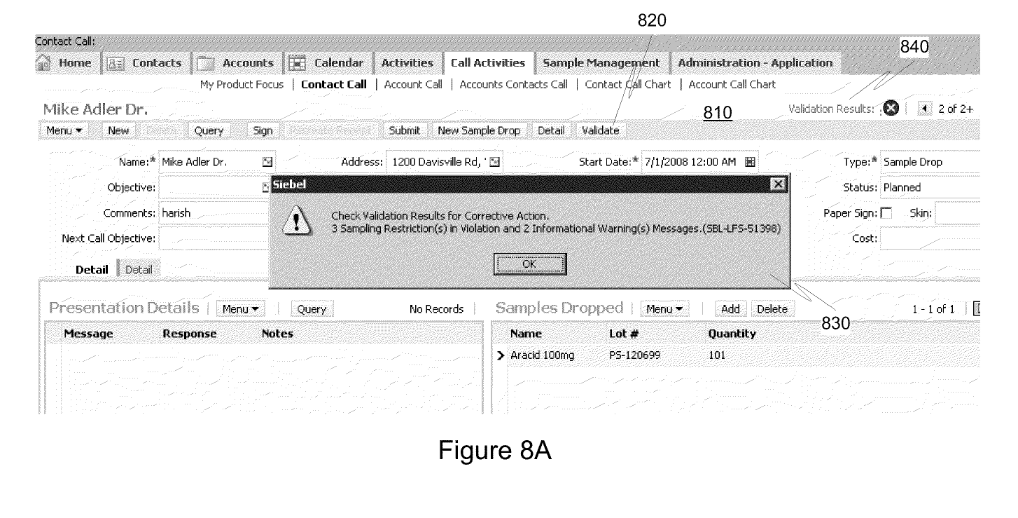

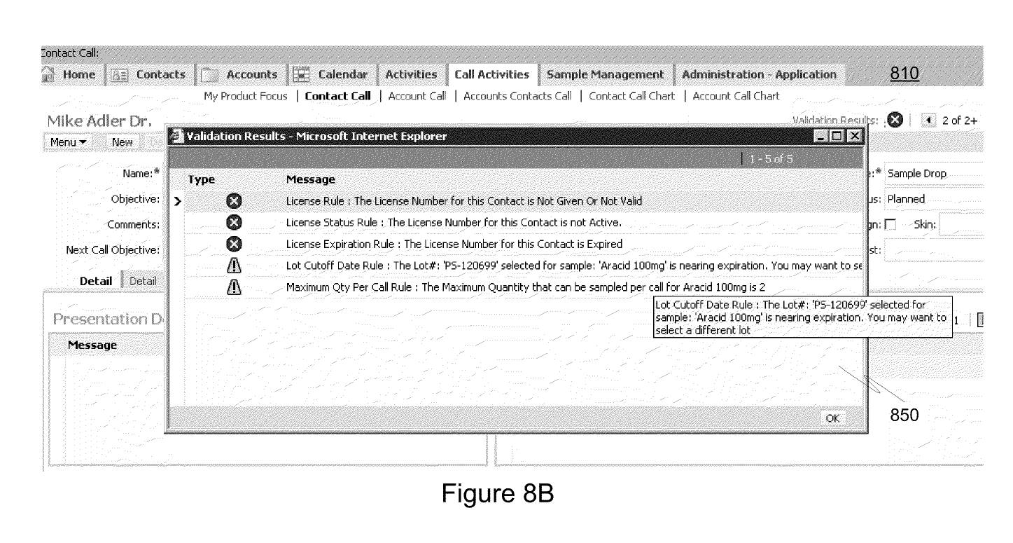

FIG. 8A illustrates an example screen shot UI 810 of the validation process. After the data is entered and validation button 820 is pressed, the validation rules are applied and result popup window 830 appears. Result popup window 830 informs the sales representative of validation results that require corrective action. The sales representative can view the details of those validation results by clicking the validation results link 840. FIG. 8B illustrates detail validation results window 850, which lists validation errors that require corrective action in a single window.

Below is example code that may be used to implement an embodiment. The code includes three functions: ParseRules, ValidateRule, and UpsertResult. ParseRules parses validation rules provided stores them in a rule data structure. ValidateRule checks if the rule can be validated; if yes, then this function invokes the method specified for the rule and stores the validation message. UpsertResult is called if existing validation results are overridden and the new validation results are to be inserted.

```
CSSLSPharmaCallValidator::ParseRules(const CCFMapStringToInt&
RuleSeqNoMap)
{
pos = RuleSeqNoMap.GetStartPosition( );
while (pos != NULL)
    {
        RuleSeqNoMap.GetNextAssoc(pos, strRule, nIndex);
        CSSLSUtilitySvc::StringSplitter(strRule, SSchar(‘, ’),
strRuleComponentsArray);
        //Validate the number of components specified in the rule
        if ((err = ValidateRuleComponents(strRuleComponentsArray)) != OK)
        {
            SSsprintf(szTempBuffer, SStext(“Validation Rule %d”), nIndex +
1);
            m_pService->SetErrorMsg(err, szTempBuffer, pErrChild);
            goto 11_abort;
        }
        CSSLSPharmaCallRule* pRule = new CSSLSPharmaCallRule( );
        strRuleName = strRuleComponentsArray.GetAt(0);
        pRule->m_strRuleName = strRuleName;
        pRule->m_nRuleSeqNo = nIndex;
        if (strRuleComponentsArray.GetSize( ) > 1)
            pRule->m_nEventToCheck = SSatoi(strRuleComponentsArray.GetAt(1));
        if (strRuleComponentsArray.GetSize( ) > 2)
            pRule->m_strMethodName = strRuleComponentsArray.GetAt(2);
        if (strRuleComponentsArray.GetSize( ) > 3)
            pRule->m_strErrMsgType = strRuleComponentsArray.GetAt(3);
        if (strRuleComponentsArray.GetSize( ) > 4)
            pRule->m_nRuleType = SSatoi(strRuleComponentsArray.GetAt(4));
        pRule->m_pfnRuleValidator = GetValidateFuncPtr(pRule-
>m_strMethodName);
        m_mapRuleToDetails.SetAt(strRuleName, pRule);
    }
}
ErrCode CSSLSPharmaCallValidator::ValidateRule(SSstring& pRuleName,
bool& bRetVal)
{
// see whether current rule is need to be validate for current call or not
DO(CanValidateRule(pRuleName, bCanValidate));
    if (bCanValidate)
    {
        //Get the Rule details
        m_mapRuleToDetails.Lookup(pRuleName, (void*&)pRule);
        SetCurrentRule(pRule);
//if current rule is not supported Out of Box Siebel product, invoke
customers written script else invoke Siebel c++ code.
        if (pRule->m_pfnRuleValidator == NULL)
        {
            CCFPropertySet inputArgs;
            CCFPropertySet outputArgs;
            inputArgs.SetProperty(SStext(“Rule Name”), pRuleName);
            DO(m_pService->CSSService::InvokeMethod(SStext(“ValidateRuleEx”),
inputArgs, outputArgs));
        }
        else
        {
            DO((this->*(pRule->m_pfnRuleValidator))(bRetVal));
        }
        SetCurrentRule(NULL);
    }
}
ErrCode CSSLSPharmaCallValidator::UpsertResult(const SSstring&
strCallId)
{
if(pBusComp->CheckActiveRow( ) == OK)
      bHasNext = TRUE;
    //Loop through all the validation messages
    for (int nCount = 0;nCount < m_objValidationMsgs.GetSize( );nCount++)
    {
        CSSLSValidationMsg objValidationMsg;
        objValidationMsg = (CSSLSValidationMsg)
m_objValidationMsgs.GetAt(nCount);
        szValidationResult[objValidationMsg.m_nSeqNum − 1] =
(objValidationMsg.m_strMsgType)[0];
        if (!bHasNext)
        {
            DOCHILD(pBusComp, NewRecord(FALSE));
        }
        DOCHILD(pBusComp, SetFieldValue(SStext(“Object Id”),m_strObjectId));
//set all field values according call results
      DOCHILD(pBusComp, SetFieldValue(SStext(“Call Id”), strCallId));
        DOCHILD(pBusComp, WriteRecord( ));
        if (pBusComp->NextRecord( ) == OK)
            bHasNext = TRUE;
        else
            bHasNext = FALSE;
    }
```

As disclosed, PSM system 10 includes a data validation rules list that is evaluated in one iteration, the results of which are presented to the sales representative in one place. Furthermore, the rules list allows users to add customized rules to validate data. Accordingly, PSM system 10 provides faster and more efficient sample detailing by quickly validating data and ensuring more accurate records and thus better government compliance.

Some embodiments of the invention have been described as computer-implemented processes. It is important to note, however, that those skilled in the art will appreciate that the mechanisms of the invention are capable of being distributed as a program product in a variety of forms. The foregoing description of example embodiments is provided for the purpose of illustrating the principles of the invention, and not in limitation thereof, since the scope of the invention is defined solely by the appended claims.

What is claimed is:

1. A method for validating pharmaceutical sales call data, comprising:
receiving a request to validate the sales call data;
retrieving a rules list comprising a plurality of rules for validating the sales call data and rule criteria;
selecting a subset of rules to apply to the sales call data from the plurality of rules based on the rule criteria;
validating the sales call data in accordance with the subset of rules, wherein each rule in the subset of rules is applied in one iteration; and
presenting to a user a user list comprising each rule in the subset of rules that failed.

2. The method of claim 1, wherein the sales call data comprises data regarding pharmaceutical samples.

3. The method of claim 1, wherein the rules list is customizable.

4. The method of claim 1, wherein the rule criteria includes for each of the plurality of rules a rule name, rule application, rule method, rule result, and rule call type.

5. The method of claim 4, where the rule application indicates that the rule is applied to one or all of:
a sales call that has not been acknowledged;
a sales call that is to be acknowledged by paper signature; and
a sales call that is to be acknowledged by electronic signature.

6. The method of claim 5, wherein the rule method indicates a method to be called when the rule is applicable.

7. The method of claim 5, wherein the rule call type indicates that the rule is applied to one or all of:
a sales call with an individual doctor;
a sales call with a conference of doctors;
a sales call with an organization.

8. A computer-readable medium having instructions stored thereon that, when executed by a processor, cause the processor to validate sales call data by:
receiving a request to validate the sales call data;
retrieving a rules list comprising a plurality of rules for validating the sales call data and rule criteria;
selecting a subset of rules to apply to the sales call data from the plurality of rules based on the rule criteria;
validating the sales call data in accordance with the subset of rules, wherein each rule in the subset of rules is applied in one iteration; and
presenting to a user a user list comprising each rule in the subset of rules that failed.

9. The method of claim 8, wherein the rules list is customizable.

10. A system for validating data entered regarding pharmaceutical samples left with a physician during a sales call, comprising:
a list of validation criteria for evaluating the data entered;
a database for storing evaluation results; and
a validation component that applies the list of validation criteria to the data entered and stores the evaluation results in the database.

11. The system of claim 10, wherein the list of validation criteria is customizable.

12. A system for validating sales call data, comprising:
means for receiving a request to validate the sales call data;
means for retrieving a rules list comprising a plurality of rules for validating the sales call data and rule criteria;
means for selecting a subset of rules to apply to the sales call data from the plurality of rules based on the rule criteria;
means for validating the sales call data in accordance with the subset of rules, wherein each rule in the subset of rules is applied in one iteration; and
means for presenting to a user a user list comprising each rule in the subset of rules that failed.

13. The system of claim 12, wherein the rules list is customizable.
